(19) United States
(12) Patent Application Publication
(10) Pub. No.: US 2020/0288192 A1
(43) Pub. Date: Sep. 10, 2020

(54) Synchronized media presentation

(71) Applicant: ECHOME, INC., Brighton, MA (US)

(72) Inventors: Christian Nicholson, Brighton, MA (US); Michael Gordon, Brighton, MA (US)

(21) Appl. No.: 16/754,615

(22) PCT Filed: Nov. 7, 2018
(86) PCT No.: PCT/US18/59709

§ 371 Date: Apr. 8, 2020

Related U.S. Application Data
(60) Provisional application No. 62/582,680, filed on Nov. 7, 2017.

(51) Int. Cl. H04N 21/43; H04N 21/845; H04N 21/8547; H04L 29/06

(52) U.S. Cl. CPC H04N 21/4307; H04N 21/8456; H04L 65/4092; H04L 65/4084; H04N 21/8547

(57) ABSTRACT

Methods and systems for synchronizing the presentation of media to a plurality of users. The system presents media to a first user at a start time, and presents the media to one or more secondary users. Based on the current time associated with the secondary user(s) and the start time, the systems and methods may adjust a playback position of the media presented to at least the secondary user(s) so that the media presented to the first user and the media presented to secondary user(s) are synchronized.

### CROSS-REFERENCE TO RELATED APPLICATIONS

This application claims the benefit of U.S. provisional application No. 62/582,680, filed on Nov. 7, 2017, the entire disclosure of which is incorporated by reference as if set forth in its entirety herein.

### TECHNICAL FIELD

Embodiments described herein generally relate to systems and methods for presenting media to a plurality of users and, more particularly but not exclusively, to systems and methods for synchronizing the presentation of media to a plurality of users.

### BACKGROUND

Existing media presentation services such as radio can reach many listeners simultaneously, but lack the advantages of internet-based services. Other media presentation tools such as music streaming services have become a widely used method of media consumption in recent years. Additionally, the increasing usage of social media has played a role in how different forms of media are consumed and shared. However, these services are unable to present media in a synchronous fashion to a plurality of users at various physical locations.

A need exists, therefore, for systems and methods that overcome the disadvantages of existing media presentation techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a system for synchronizing the presentation of media to a plurality of users. The system includes an interface in communication with at least a first client application accessible by a first user and a second client application accessible by a second user; and at least one processor executing instructions stored on a memory to present media to the first user at a start time using the first client application, receive a current time associated with the second client application, and adjust a playback position of the media presented to the second user based on the current time and the start time so that the media presented to the first user and the media presented to the second user is synchronized.

In some embodiments, the interface is further configured to receive a selection of the media to be presented from the first user.

In some embodiments, the system further includes a database module configured to store a path to the media and a timestamp indicating the start time, wherein the path to the media and the timestamp indicating the start time are accessible by the second client application.

In some embodiments, the media includes at least one of visual stimuli, audio stimuli, olfactory stimuli, tactile stimuli, and taste-based stimuli.

In some embodiments, the media presented to the first user and the second user is synchronized within 30 milliseconds.

In some embodiments, the current time is received from a time device local to the second client application and is based on the Network Time Protocol (NTP).

In some embodiments, the first and second client applications are configured to receive at least one interaction from at least one of the first user and the second user, wherein the received interaction is accessible by the first user and the second user. In some embodiments, the at least one processor is further configured to assign a score to at least one of the users based on the interactions received from the at least one of the users.

In some embodiments, the processor is further configured to adjust a playback position of media presented to a plurality of users each using a client application so that the media presented to the plurality of users is synchronized.

According to another aspect, embodiments relate to a method for synchronizing the presentation of media to a plurality of users. The method includes presenting, using at least one processor executing instructions stored on a memory, media to a first user at a start time using a first client application; presenting, using the at least one processor, the media to a second user using a second client application; receiving, using the at least one processor, a current time associated with the second client application; and adjusting, using the at least one processor, a playback position of the media presented to the second user based on the current time and the start time so that the media presented to the first user and the second user is synchronized.

In some embodiments, the method further includes receiving, using an interface in communication with the first client application, a selection of the media to be presented from the first user.

In some embodiments, presenting the media to the second user includes writing a path to the media to a database module and writing a timestamp indicating the start time to the database module, wherein the path to the media and the timestamp indicating the start time are accessible by the second client application.

In some embodiments, the media includes at least one of visual stimuli, audio stimuli, olfactory stimuli, tactile stimuli, and taste-based stimuli.

In some embodiments, the media presented to the first user and the second user is synchronized within 30 milliseconds.

In some embodiments, the current time is received from a time device local to the second client application and is based on the Network Time Protocol (NTP).

In some embodiments, the method further includes receiving at least one interaction from at least one of the first user and the second user, wherein the received interaction is accessible by the first user and the second user. In some embodiments, the method further includes assigning a score to at least one of the users based on the interactions received from the at least one of the users.

In some embodiments, the method further includes adjusting a playback position of media presented to a plurality of users each using a client application so that the media presented to the plurality of users is synchronized.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a system for synchronizing the presentation of media to a plurality of users in accordance with one embodiment;

FIG. 2 illustrates a user device in communication with a local time device to obtain the current time associated with the user device in accordance with one embodiment; and

FIG. 3 depicts a flowchart of a method for synchronizing the presentation of media to a plurality of users in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed previously, media presentation techniques such as music streaming services do not allow for the synchronized presentation of media to multiple users. For example, music presented to users at different physical locations may not be synchronized due to the inherent lag associated with transmitting the media data to the intended users.

The systems and methods described herein overcome the disadvantages of existing media sharing techniques to synchronously present media to a network of users. The systems and methods described herein may also present the media in a social, interactive environment. Accordingly, in some embodiments the result is a new form of social media that presents media (such as music or other type of stimuli) to many users in a synchronized fashion and in an interactive environment.

Although the present application largely discusses music as the relevant media, the systems and methods described herein may present any other type of media. This may include, but is not limited to, visual stimuli, audio stimuli, olfactory stimuli, tactile stimuli, and taste-based stimuli. For simplicity, however, and unless otherwise noted, the present application will discuss the systems and methods in the context of music.

In some embodiments, a first user (also referred to as a “host”) on a network may select a song for presentation to the first user and one or more other users on a network. The systems and methods described herein may then present the selected song to the first user at a start time. One or more secondary users on or otherwise in communication with the network may also want to listen to the selected song. These users may execute a client application on any suitable user device to receive the song for presentation.

Due to the secondary users' physical locations with respect to, for example, the first user's physical location, there may be a time lag resulting from the time it takes for the data associated with the selected song to travel to the secondary user(s) relative to the time associated with the selected song to travel to the first user. As a consequence, the portion of the song presented to the first user at a given time may be different than the portion of the song presented to the secondary user(s) at that same time. In other words, the first user and the secondary user(s) may hear different segments of the song at the same time due to location and/or lag and thus the songs presented to the first and secondary users are not synchronized in their presentation. This is undesirable, and it is preferable that the music presented to all users is synchronized so that all users hear the same portion of the song at the same time to facilitate, e.g., meaningful commentary and messages exchanged among the users as they listen to the song.

The systems and methods described herein may account for this lag and adjust the playback position of the media presented to at least one or more of the secondary users. Specifically, the systems and methods in accordance with various embodiments may analyze a current time associated with the secondary user(s) and the start time at which the song started playing to the first user. The systems and methods described herein may then adjust the playback position of the song presented to at least the one or more secondary user(s) to achieve simultaneous playback for all users.

Additionally, the systems and methods described herein provide a socially interactive environment in which users may interact witch each other and the media in a variety of ways. These may include, but are not limited to: (1) the ability for the first user/host to allow/disallow users to join the broadcast and to add/remove media resources from the broadcast's queue in real-time; (2) the ability for the first user and all synchronized users to chat with each other in real-time via a text messaging or SMS interface while the media plays on all client applications; (3) the ability for the first user or any connected user to invite other, currently unconnected users to join a broadcast; (4) the ability for the first user to change the media source used in the broadcast at any time (e.g., the host may begin broadcasting a song from a first streaming service to one or more secondary users and then broadcast a song from a second streaming service); and (5) the ability for the first user/host to prevent unconnected clients from joining the broadcast.

In some embodiments, the systems and methods described herein enable the synchronization of media within, for example, +/−15 milliseconds. In other words, any two or more users tuned into a given broadcast (including the first user) can experience substantially synchronized presentations of the same media no more than 30 milliseconds apart from one another.

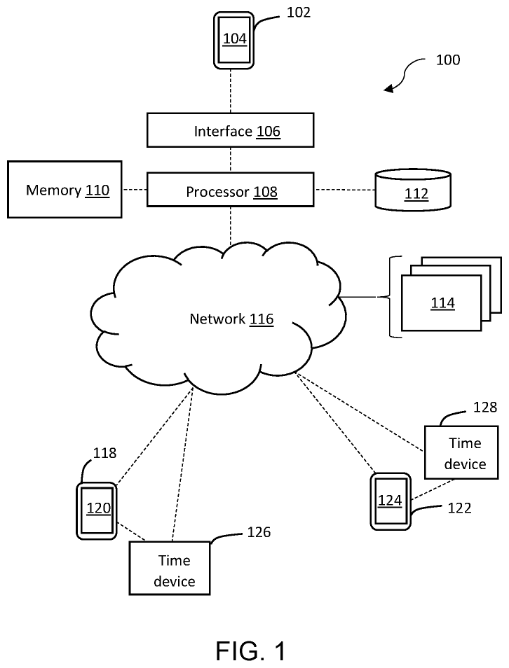

FIG. 1 illustrates a system 100 for synchronizing the presentation of media in accordance with one embodiment. The system 100 may include a first user device 102 executing a first client application 104 accessible by a first user (not shown in FIG. 1). The first client application 104 may be in further communication with an interface 106, one or more processors 108 executing instructions stored on a memory 110, and one or more database modules 112.

The first user device 102 may be any appropriate device that presents the media of interest and allows the first user to input instructions. The user device 102 may be configured as, for example, a smartphone, tablet, laptop, PC, smartwatch, or any other type of device configured to present the media of interest.

The first client application 104 executing on the first user device 102 may enable the first user to select any suitable media (e.g., a particular song) from one or more third party sources 114 over one or more networks 116. For music in particular, these third party music sources 114 or services may include SPOTIFY®, SOUNDCLOUD®, APPLE MUSIC®, or the like.

The interface 106 may receive instructions from the first client application 104 regarding, for example, one or more songs for presentation to the users on or otherwise in communication with the one or more networks 116. The received instructions may be communicated to the one or more processors 108 for execution.

For example, the first client application 104 may make requests via various protocols (e.g., HTTP/HTTPS, or the like). In the context of music, an audio resource can include a requestable object containing information that may include an audio file (.mp3, .wav, .alac, .flac, etc.), a title for the resource, the creator of the resource, the uploader of the resource, the address of the resource, the duration of the audio file, the creator of the audio file (if different than the creator of the resource), and the like. The first user acts as a host that has initiated a broadcast for multiple users.

The one or more processors 108 can implement any required digital electronic circuitry, integrated circuitry, specially designed application specific integrated circuits (ASICs), field programmable gate arrays (FPGAs) computer hardware, firmware, software stored on memory 110, and/or combinations thereof.

The processor(s) 108 can execute one or more computer programs on memory 110 to receive data and instructions from, and to transmit data and instructions to, a storage system and/or at least one input/output device such as the user device 102. The programmable system or computing system may include clients and servers. A client and server are generally remote from each other and typically interact through a communication network such as the network(s) 116. The relationship of client and server arises by virtue of computer programs running on the respective computers and having a client-server relationship to each other.

The network(s) 116 may link the various devices with various types of network connections. The network(s) 116 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network(s) 116 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

There may be one or more secondary users on or otherwise in communication with the network(s) 116 that each operate a secondary user device. For example, FIG. 1 also shows a second user device 118 executing a second client application 120, and a third user device 122 executing a third client application 124. Users of devices 118 and 122 may view or otherwise experience the media selected by the first user via the second client application 120 and the third client application 124, respectively.

Although only one processor 108 is shown in FIG. 1, the system 100 may include multiple processing devices in various configurations. For example, the system 100 may include a processing device configured with or otherwise in communication with each user device. Or, a single processor may perform all computations required for synchronizing the media presented to the users.

The second and third user devices 118 and 122 may also be in operable communication with local time devices 126 and 128, respectively. The user devices may rely on the local time devices to determine the local time associated with each user device. For example, if the user device 118 is located in Boston, Mass., then the accurate local time will be that associated with the Eastern Time zone (EST/EDT/UTC −5 h, etc.).

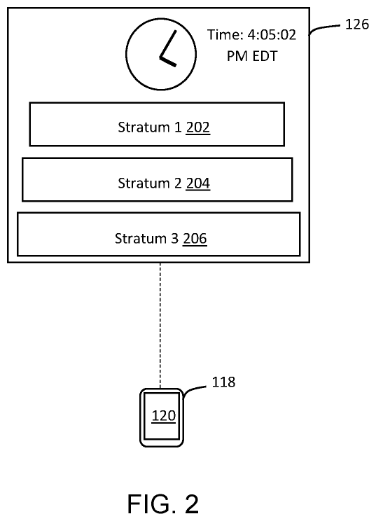

Specifically, the time devices 126 and 128 may rely on the Network Time Protocol (NTP) to determine the correct time. FIG. 2, for example, illustrates the second user device 118 in communication with the local time device 126. The local time device 126 may communicate the current time utilizing NTP. The time communicated to the second user device 118 may be communicated from any appropriate stratum 202, 204, 206, etc. in accordance with NTP. By relying on a time device such as the time device 126 of FIGS. 1 and 2, the user devices and, specifically, the client applications, can receive an accurate time associated therewith. Although not shown in FIG. 1, the first user device 102 may also be in operable communication with a local time device to determine the time associated with the first user device 102.

The processor(s) 108 may receive a start time at which the media is first presented to the first user. For example, the start time may correspond to a time a song starts playing. The start time may be determined by the time received from a time device associated with the first user device 102 (not shown in FIG. 1).

The retrieved current time can be accurate within 10 milliseconds of the actual time (e.g., according to the International Atomic Time and/or Universal Time Coordinated or any other international or national time standard). The current time for each user device is determined by its associated local time device, which can have been previously adjusted to an accurate time by retrieving the time from a reliable time source (e.g., a stratum 1, 2, or 3 time server) utilizing NTP.

The start time and the path to the selected media can be written to one or more database modules 112 where they can be retrieved by the second client application 120. Once the second client application 120 retrieves the start time and the media from the database module(s) 112, the second client application 120 may begin playback of the media and adjust the playback position of the media based on the start time and the current time associated with the second user device 118. In some implementations, the second client application 120 may prepare the media for presentation, adjust the playback position of the media based on the start time and the current time, and then begin playing the media from the appropriate playback position to achieve simultaneous playback for the users.

In some embodiments, the client applications may be programmed to adjust the playback position of a media file to a certain millisecond using a respective media player command. For example, many media playing devices (e.g., smart phones) and streaming services include software development kits (SDK) that come with an appropriate media player protocol that can be configured to adjust the playback position of the presented media.

For example, if a first user began listening at 5 p.m. local time and is 33 seconds into a song, then a secondary user at 5:00:10 p.m. local time would receive a streaming feed that is 10 seconds ahead of the first user (i.e., 43 seconds into the song) such that the lagged feed would have both users listening at 43 seconds into the song despite the lag.

Other authorized users may similarly retrieve the selected media and the start time from the database modules 112 at any time after they are written and while they remain readable. The media written to the database module 112 can be referred to as “common media.” Users may retrieve the start time and the common media via requests over known protocols such as HTTP/HTTPS, or the like.

After using the processes described, client applications presenting the common media utilizing the start time will be presenting said common media in synchronization to a plurality of geographically-disparate users. In other words, the client applications can be perceived as presenting the common media simultaneously and indistinguishably in timing such that if a single person is surrounded by multiple client devices that are presenting the common media and having utilized the start time and the associated current time, they would not be able to distinguish any noticeable difference in the playback position of the common media across any two or more of the devices.

While viewing, listening to, or otherwise exposed to the presented media, users may use their client applications to interact with the media and/or other users. For example, a user may provide a comment expressing their enjoyment of a particular song and/or a particular feature or part of the song. Users may provide other interactions indicating they like the song such as by clicking a “like” button. As another example, users (or only the host/first user) may invite others to join the broadcast of the media.

In some embodiments, the systems and methods described herein may assign scores to one or more of the users. This score may be represented by a numerical value and calculated using known metrics based on the user's interactions on the network. Generally speaking, a user's interactions may help define the user's experience as a broadcaster and as a sharer of media on the network, and the score can indicate their value to the network.

For example, a user may receive points or otherwise have their score increased by some amount for each follower they have and/or based on the number of synchronized devices in a broadcast they're hosting. Additionally or alternatively, a user may accrue points for each song they share or broadcast. A user may also accrue points or otherwise have their score increased each time they join a broadcast. Users may also increase their score by providing comments with respect to a song or by providing other types of interactions.

To allow users to provide these interactions, one or more aspects or features of the subject matter described herein can be implemented on a computer having a display device, such as a cathode ray tube (CRT), a liquid crystal display (LCD), or a light emitting diode (LED) monitor for displaying information to the user, and a keyboard and a pointing device (e.g., a mouse, trackball, stylus, etc.) by which the user may provide input to the computer. Other kinds of devices can provide for interaction with a user as well. For example, feedback provided to the user can be in any form of visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

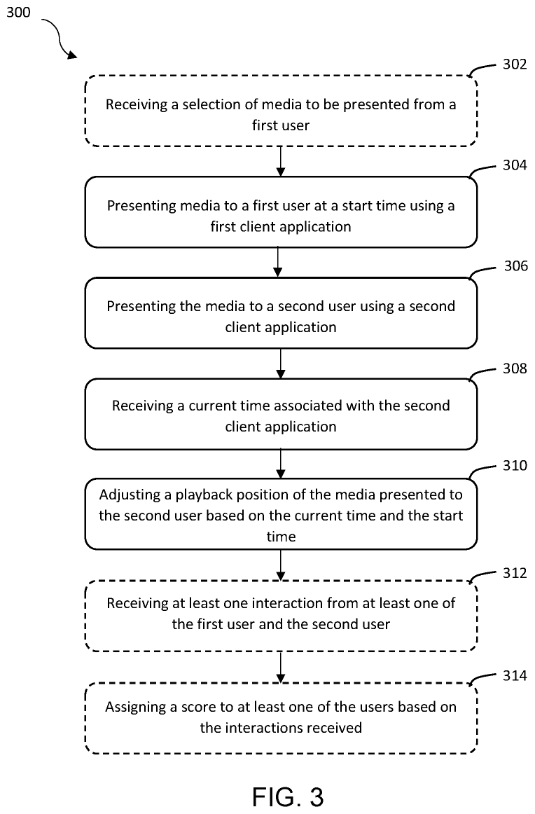

FIG. 3 depicts a flowchart of a method 300 for synchronizing the presentation of media to a plurality of users in accordance with one embodiment. Step 302 is optional and involves receiving a selection of media to be presented from a first user. In this scenario, the first user may act as a host of a broadcast and select one or more media segments (e.g., songs, videos, etc.) for presentation to the first user and any other authorized secondary users.

Although step 302 involves receiving a selection of media, some embodiments may autonomously select media to be presented to the users without requiring a user to select the media. For example, the systems and methods described herein may select one or more songs for presentation from a library of songs.

Step 304 involves presenting, using at least one processor executing instructions stored on a memory, media to a first user at a start time using a first client application. Step 304 may be performed by a first client application executing on a first user device accessible by a first user. The start time may be the time at which the media begins presentation to the user (e.g., the time at which a song or video starts). The start time, along with a path to the presented media, may be stored in one or more database modules accessible by at least one other user.

Step 306 presenting, using the at least one processor, the media to a second user using a second client application. The second client application may execute on a second user device to present the media to a second user. The second user may be a user authorized to experience the presented media. For example, the first user may invite the second user to join the broadcast by sending the second user a link in a text or email message.

Due to the second user's physical location, however, there may be lag with respect to the playback position of the media presented via the second client application with respect to the playback position of the media presented to the first user. In other words, the media presented to the second user may be “behind” the media presented to the first user.

Step 308 involves receiving, using the at least one processor, a current time associated with the second client application. As discussed previously, each user device may be in communication with a local time device that may be based on NTP to determine the time associated with that particular user device. The current time may be the same for one or more users, but may very well be different for different users.

Step 310 involves adjusting, using the at least one processor, the playback position of the media presented to the second user based on the current time and the start time so that the media presented to the first user and the second user is synchronized. For example, one or more processors associated with the second client application may advance the media presented to the second user by an appropriate amount based on the lag (i.e., the difference in local time between the first and second users) so that the media presentation to the first and second users is synchronized. Accordingly, the first and second users perceive simultaneous playback.

Although step 310 involves adjusting the playback position of the media presented to the second user, the systems and methods described herein may additionally or alternatively adjust the playback position of the media presented to the first user. For example, if the media presented to the second user was 30 milliseconds behind the media presented to the first user, then the media presented to the first user may be set back 15 milliseconds and the media presented to the second user may be set forward 15 milliseconds.

Certain steps of method 300 may also be performed in a different order than that illustrated in FIG. 3. For example, the playback position of the media may be adjusted as required before the media is presented to the second user.

Step 312 is optional and involves receiving at least one interaction from at least one of the first user and the second user, wherein the received interaction is accessible by the first user and the second user. An interaction may include, for example, a comment provided by a user indicating that particular user's thoughts on the presented media.

Step 314 is optional and involves assigning a score to at least one of the users based on the interactions received from the user. As discussed previously, this score may represent a user's value to the network. For example, a user's score may increase as the user provides more comments (especially if those comments are received favorably by the other users).

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A system for synchronizing the presentation of media to a plurality of users, the system comprising:
an interface in communication with at least a first client application accessible by a first user and a second client application accessible by a second user; and
at least one processor executing instructions stored on a memory to:
present media to the first user at a start time using the first client application,
receive a current time associated with the second client application, and
adjust a playback position of the media presented to the second user based on the current time and the start time so that the media presented to the first user and the media presented to the second user is synchronized.

2. The system of claim 1 wherein the interface is further configured to receive a selection of the media to be presented from the first user.

3. The system of claim 1 further comprising a database module configured to store:
a path to the media, and
a timestamp indicating the start time,
wherein the path to the media and the timestamp indicating the start time are accessible by the second client application.

4. The system of claim 1 wherein the media includes at least one of visual stimuli, audio stimuli, olfactory stimuli, tactile stimuli, and taste-based stimuli.

5. The system of claim 1 wherein the media presented to the first user and the second user is synchronized within 30 milliseconds.

6. The system of claim 1 wherein the current time is received from a time device local to the second client application and is based on the Network Time Protocol (NTP).

7. The system of claim 1 wherein the first and second client applications are configured to receive at least one interaction from at least one of the first user and the second user, wherein the received interaction is accessible by the first user and the second user.

8. The system of claim 7 wherein the at least one processor is further configured to assign a score to at least one of the users based on the interactions received from the at least one of the users.

9. The system of claim 1 wherein the processor is further configured to adjust a playback position of media presented to a plurality of users each using a client application so that the media presented to the plurality of users is synchronized.

10. A method for synchronizing the presentation of media to a plurality of users, the method comprising:
presenting, using at least one processor executing instructions stored on a memory, media to a first user at a start time using a first client application;
presenting, using the at least one processor, the media to a second user using a second client application;
receiving, using the at least one processor, a current time associated with the second client application; and
adjusting, using the at least one processor, a playback position of the media presented to the second user based on the current time and the start time so that the media presented to the first user and the media presented to the second user is synchronized.

11. The method of claim 10 further comprising receiving, using an interface in communication with the first client application, a selection of the media to be presented from the first user.

12. The method of claim 10 wherein presenting the media to the second user includes:
writing a path to the media to a database module, and
writing a timestamp indicating the start time to the database module,
wherein the path to the media and the timestamp indicating the start time are accessible by the second client application.

13. The method of claim 10 wherein the media includes at least one of visual stimuli, audio stimuli, olfactory stimuli, tactile stimuli, and taste-based stimuli.

14. The method of claim 10 wherein the media presented to the first user and the second user is synchronized within 30 milliseconds.

15. The method of claim 10 wherein the current time is received from a time device local to the second client application and is based on the Network Time Protocol (NTP).

16. The method of claim 10 further comprising receiving at least one interaction from at least one of the first user and the second user, wherein the received interaction is accessible by the first user and the second user.

17. The method of claim 16 further comprising assigning a score to at least one of the users based on the interactions received from the at least one of the users.

18. The method of claim 10 further comprising adjusting a playback position of media presented to a plurality of users each using a client application so that the media presented to the plurality of users is synchronized.
